(19) United States
(12) Patent Application Publication
(10) Pub. No.: US 2013/0108712 A1
(43) Pub. Date: May 2, 2013

(54) AGENT FOR CLEANING THE INTERIORS OF SHOES

(71) Applicant: Meinrad Flury, Kerzers/FR (CH)

(72) Inventor: Meinrad Flury, Kerzers/FR (CH)

(73) Assignee: JOKER AG, Kerzers/FR (CH)

(21) Appl. No.: 13/635,351

(22) PCT Filed: Mar. 14, 2011
(86) PCT No.: PCT/EP2011/053812

§ 371 Date: Oct. 15, 2012

(30) Foreign Application Priority Data
Mar. 18, 2010 (CH) 395/10

(51) Int. Cl. A01N 31/02; A01N 59/14; A01N 33/04

(52) U.S. Cl. CPC A01N 31/02; A01N 33/04; A01N 59/14
USPC 424/659; 514/724; 514/642

(57) ABSTRACT

To clean the inside of shoes, a means is proposed in the form of a highly viscous modelling material, consisting of native guar and 75% to 95% by weight combined water and disinfectant with a liquid antiseptic action and aluminium chloride-containing cleaning agents, as well as antimicrobial and anti-fungicidal agents, wherein the consistency is such that the agent is able to adapt to the inside and the inner and outer surfaces of open and closed-toe shoes under the effect of gravity.

The present invention relates to a means of cleaning the inside and the inner and outer surfaces of open and closed-toe shoes.

For well over 100 years people have been preoccupied with cleaning the outside of shoes and therefore improving the aesthetic appearance of shoes. This was originally limited to the purely mechanical cleaning of shoes and the following treatment of the leather. The cleaning was purely mechanical, usually involving brushing and treatment with grease or wax to impregnate the leather. Chemical means for cleaning the outsides of shoes have also been known for some time, as is demonstrated by, for example, U.S. Pat. No. 1,447,879 or U.S. Pat. No. 1,439,915.

It is only recently that hygiene considerations have come to the fore. So, for instance, EP 1234517 discloses a device in which a method is used for cleaning shoes in which the shoes are irradiated with ultraviolet light and exposed to an ozone-containing atmosphere. However, this treatment is not intended for private use, but for the pre-treatment of soles, in order to improve their grip. Commonly used in households, however, are so-called shoe deodorants, which contain a large proportion of volatile carrier substances, such as butanes, alcohols, propanes and water, in addition to certain disinfectants, odour-binding agents such as zinc ricinoleate, for example. Zinc ricinoleate possesses the odour eliminating property, without thereby having an inhibiting effect on bacteria, fungi or transpiration. There are, however, known shoe deodorants that have an inhibiting effect on bacteria or also an anti-fungicidal effect. A cleaning effect, particularly with regard to deposits, is naturally not achieved with these types of shoe deodorants. Instead, they generate additional burdens.

It is a well-known fact that dirt, bacteria and viruses can cause various skin diseases and allergies. Relatively warm, moist environments are created, particularly in closed-toe shoes. Bearing in mind that most people wear shoes for eight hours or more a day, it is not surprising that germs and viruses have enough time to multiply and accumulate on the feet. These germs and viruses not only cause unpleasant odours, but they pollute and contaminate shoes and therefore feet. Statistics speak a clear language in this respect. It is assumed that in Europe alone some 550 million people suffer from foot odour. In the USA around 122 million people suffer from athlete's foot (tinea pedis). In the USA alone there are calculated to be 21 million people affected by plantar warts, which are caused by the human papillomavirus. It is assumed that around 290 million adults worldwide suffer from fungal nail infection and roughly 1.34 billion people carry the Staph aureus bacterium around with them, which causes different diseases and allergies affecting the feet too.

The shoe sprays commonly available today are difficult to apply. A large part of the spray does not even get into the shoes and causes pollution of the air with the quickly evaporating solvents contained in it. Also, the germs and viruses that have been killed remain in the shoes, in turn providing a food source for new germs and viruses, which are thereby able to multiply exponentially. In addition, as a result of the actual foot movement, different particles such as skin, fabric, etc. are abraded by the kinetic energy and also therefore provide a basis on which germs and viruses can subsist. In addition to this, most sprays only contain one or two antibacterial substances and prolonged action in shoes is barely achievable.

The Japanese patent application JP 10276961-A discloses a detergent which does not trigger allergic reactions. This detergent is used to clean shoes and is sprayed inside them. The developed means has a plant-based formulation and is dissolved in water in the form of micro-particles and sprayed under pressure into the shoes being cleaned. To increase the sterilising grease and kill off fungus, water containing ozone acid is also sprayed in. Combined physical and chemical cleaning of the inside of the shoes does not therefore take place here either. Consequently, the object of the present invention is to create a cleaning agent that produces this dual effect.

This object of cleaning the inside of shoes is achieved according to the invention with a cleaning compound in the form of a highly viscous modelling material consisting of native guar and 75% to 95% by weight combined water and disinfectant with a liquid antiseptic action and aluminium chloride-containing cleaning agents, as well as antimicrobial and anti-fungicidal agents, wherein the consistency is such that the agent is able to adapt to the inside or surface of the shoe and enclose the loose particles.

Possible disinfectants preferably include alcohol or ethanol. Other forms of alcohol are naturally also conceivable. As the anti-fungicidal agent, a maximum of up to 0.5% by weight methylparaben is preferably added.

Various active ingredients are likewise possible for improving durability. Up to maximum 0.5% by weight propylparaben is preferably added in this case.

Small amounts of aromatic substances and also dyes are naturally also added.

The aromatic substances may likewise provide an antibacterial effect, as certain substances of these, such as citral and silver ions, for example, are also known for their antibacterial action.

A general, preferred formulation with reasonable ranges is reproduced below in % by weight.

| | |
|---|---|
| Water (H₂O) | 65-75% |
| Ethanol | 10-20% |
| Propantriol | 5-8% |
| Native guar | 3-7% |
| Alkyldimethylbenylammonium chloride | 2-7% |
| Didecyl dimethyl ammonium chloride | 1-4% |
| Boron (as boracic acid) | 0.1-0.5% |
| Methylparaben | <0.5% |
| Propylparaben | <0.5% |
| Dye | 0.001-0.003% |
| Aromatic substance | 0.0001-0.001% |
| Diazolidinyl urea | 0.001-0.005% |

It goes without saying that different formulations are possible within these ranges, producing a cleaning compound with a higher or less high viscosity, as the case may be. The cleaning compound according to the invention may be pressed by the user straight into the shoe and thanks to its high cohesion values, the cleaning compound, which acts as a modelling material in terms of its consistency, can also be pulled out again in one piece. Physical impurities are thereby softened at the same time and adhere to the cleaning compound along with fluff from socks or other impurities. These impurities are neutralised by the mixed-in substances, which are also dispensed in small quantities onto the surfaces within the shoe.

With a few kneading actions, these impurities are kneaded into the compound, wherein the surface of the cleaning compound is changed at the same time and the new cleaning compound surface is available again for further cleaning purposes. The cleaning compound does not therefore have to be disposed of after a single use, but instead can be used many times over. Because the cleaning compound is a liquid overall and is therefore fluid, it adapts to the shape of the inside of the shoe under the effect of gravity. This takes a longer or shorter time, depending on the viscosity. Accordingly, the cleaning compound may also only be pressed on for a short time and then immediately removed again or left in the shoe for a longer time before it is removed. Because the water and other fluids present in the formulation are bound, there is a slight moistening action on the inside of the shoe. This action is desirable, as the wetness lingering for a while on the surface is also able to loosen grease and other stubborn solid particles.

The formulation described here, with its relatively high proportion of 5-8% by weight propantriol, also contains an agent with conditioning properties for shoe leather. This relatively high proportion of glycerine keeps the leather soft and supple inside the shoe too.

The moulding compound according to the invention has a prophylactic action against foot diseases, such as tinea pedis, tinea unguium (fungal nail infection) and candidiasis (thrush). Tests on the moulding compound formulation indicated here have shown after an exposure time of a few minutes that up to 99% of all these germs could be killed off. Following removal of the cleaning compound, a sharp reduction of up to 100% of loose particles and germs was determined in the shoes treated in this way and the formation of odours was therefore also actively eliminated. This is in pure contrast to the many sprays, which only try to mask unpleasant odours by adding aromatic substances.

Alkyldimethylbenylammonium chlorides in a proportion of 2-7% by weight have proved particularly effective disinfectants. The effect could also be further improved by the disinfectant didecyl dimethyl ammonium chloride, which can also be used effectively in combination with the aforementioned disinfectant and other disinfectants. Boracic acid has also proved suitable as a disinfectant, which can be used here in a quantity of 0.1-0.5% by weight.

The addition of less than 0.5% by weight methylparaben increases the durability of the cleaning compound. Propylparaben, which is preferably also added to the cleaning compound in a quantity of less than 0.5% by weight, possesses this effect and also a certain cleaning effect.

Cleaning compounds with a viscosity of between 50,000 and 150,000 mPa.s. can be achieved using the formulation indicated here. This means the cleaning compound is also able to penetrate gaps, slits and seams, while the inner cohesion is nevertheless great enough for the compound to stay together when it is removed. The cleaning compound is thereby able to absorb or encapsulate impurities, kill off germs and viruses, neutralise odours and incorporate the dead bacteria by adhesion.

1. An agent for cleaning the inside and the inner and outer surfaces of open and closed-toe shoes, wherein the composition is a highly viscous moulding material comprising native guar; 75% to 95% by weight combined water and disinfectant with a liquid antiseptic action: aluminium chloride-containing cleaning agents: and antimicrobial and anti-fungicidal agents, wherein the composition has a consistency such that the composition is able to adapt to the inside or inner and outer surfaces of the shoe and enclose the loose particles.

2. The agent according to claim 1, wherein the disinfectant is an alcohol.

3. The agent according to claim 1, wherein the disinfectant is ethanol.

4. The agent according to claim 3, further comprising alkyldimethylbenylammonium chloride as an additional disinfectant.

5. The agent according to claim 3, further comprising didecyl dimethyl ammonium chloride as an additional disinfectant.

6. The agent according to claim 3, further comprising boracic acid as a further disinfectant.

7. The agent according to claim 1, wherein the moulding material has a viscosity of between 50,000 and 80,000 mPa.s.

8. The agent according to claim 1, further comprising a maximum of 0.5% by weight methylparaben as an anti-fungicidal agent.

9. The agent according to claim 1, further comprising a maximum of 0.5% by weight propylparaben to improve durability.

10. The agent according to claim 1, further comprising diazolidinyl urea to improve durability.

11. The agent according to claim 1, wherein the agent has a moistening action, which dissolves grease and other stubborn solid particles and then adsorbs them.

12. The agent according to claim 1 wherein the agent exhibits a prophylactic action against foot diseases.

13. The agent according to claim 1, wherein the agent has the following composition:

| | |
|---|---|
| Water (H₂O) | 65-75% |
| Ethanol | 10-20% |
| Propantriol | 5-8% |
| Native guar | 3-7% |
| Alkyldimethylbenylammonium chloride | 2-7% |
| Didecyl dimethyl ammonium chloride | 1-4% |
| Boron (as boracic acid) | 0.1-0.5% |
| Methylparaben | <0.5% |
| Propylparaben | <0.5% |
| Dye | 0.001-0.003% |
| Aromatic substance | 0.0001-0.001% |
| Diazolidinyl urea | 0.001-0.005% |
